(19) United States
(12) Patent Application Publication
(10) Pub. No.: US 2010/0015266 A1
(43) Pub. Date: Jan. 21, 2010

(54) DEVICE FOR MELT-SPINNING SYNTHETIC FILAMENTS

(75) Inventors: Günter SCHÜTT, Neumunster (DE); Volker BIRKHOLZ, Neumunster (DE)

Correspondence Address: BAINWOOD HUANG & ASSOCIATES LLC, 2 CONNECTOR ROAD, WESTBOROUGH, MA, 01581, US

(73) Assignee: OERLIKON TEXTILE GMBH & CO. KG, Remscheid (DE)

(21) Appl. No.: 12/542,306

(22) Filed: Aug. 17, 2009

Related U.S. Application Data
(63) Continuation of application No. PCT/EP2008/051815, filed on Feb. 14, 2008.

(30) Foreign Application Priority Data
Feb. 24, 2007 (DE) 10 2007 009 130.5

(51) Int. Cl. B29C 47/30

(52) U.S. Cl. 425/72.2

(57) ABSTRACT

A device for melt-spinning synthetic filaments includes a spin-die manifold for holding at least one bank of spinnerets and heating device for heating the bank of spinnerets. At least one spinneret with second heating device for heating the spinning pump is allocated to the bank of spinnerets and the spinning pump and bank of spinnerets are interconnected by a melt line. To achieve a user-friendly arrangement for the bank of spinnerets and the spinning pump, the pump and the second heating device are held by a separate pump support which is placed at a distance from the spin-die manifold. This allows the spinning pump to be heated independently of the spin-die manifold.

### CROSS REFERENCE TO RELATED APPLICATIONS

This patent application is a Continuation of International Patent Application No. PCT/EP2008/051815 filed on Feb. 14, 2008, entitled, “DEVICE FOR MELT-SPINNING SYNTHETIC FILAMENTS”, the contents and teachings of which are hereby incorporated by reference in their entirety.

### TECHNICAL FIELD

The invention relates to a device for melt spinning synthetic filaments having a spin-die manifold for accommodating at least one bank of spinnerets, and heating devices for heating the spinnerets.

### BACKGROUND

Devices for melt spinning synthetic filaments are known in the art. For example, a conventional device is disclosed in WO2005/123994 A1, entitled “Device for spinning filaments”.

This device includes a spin-die manifold holding multiple banks of spinnerets on the bottom thereof in a row-shaped arrangement. For heating the banks of spinnerets the spin-die manifold forms a heating chamber, which surrounds the receptacles of the banks of spinnerets in the interior of the spin-die manifold. A spinning pump is arranged on the top of the spin-die manifold, which is mounted to the top of the spin-die manifold utilizing a pump connection block. A heating device is associated with the spinning pump, which surrounds the spinning pump with a heating medium in the form of a heater jacket. The spinning pump is formed by a multiple pump, and is connected to the banks of spinnerets by means of multiple melt lines. In practice, the pump connection blocks are preferably screwed to the spin-die manifolds.

### SUMMARY

Due to frequent heating and cooling down of the spin-die manifold mechanical connections such as those of WO2005/123994, a great amount of stress on the connections occurs, such that periodic controls and re-tightening of the screws when screws are utilized is necessary in order to prevent any possible leaks. This requires extensive disassembly work. Furthermore, it is common with the production of synthetic threads that a plurality of banks of spinnerets and spinning pumps are held on the spin-die manifold. For this purpose it is of disadvantage that each of the spinning pumps mounted on the spin-die manifolds must be associated with a separate heating device in order to obtain temperature control of the melt-carrying components. For this purpose temperature differences can hardly be avoided.

A device for melt spinning synthetic filaments of the generic type, wherein the spinning pump and the bank of spinnerets are held in an arrangement that is low in maintenance and easy to operate is provided. The device enables a temperature control of the banks of spinnerets and spinning pumps, which is uniform and adjusted to the function of the assemblies. In one embodiment, a spinning pump and second heating device are held in a separate pump support, which is arranged at a distance adjacent to the spin-die manifold.

The device for melt spinning synthetic filaments disclosed herein departs from the current concept of holding the components required for conveying the melt and the extrusion of the melt on a mutual carrier. The separation between a spin-die manifold and a separate pump support according to the invention has the particular advantage that a temperature control adjusted to the function of the respective assembly can be carried out without any reciprocal influencing. The device also provides for a particularly flexible arrangement of the spinning pumps within the pump support such that the drive is aligned vertically or horizontally, or if necessary, can be carried out in a transverse position. The arrangement of the pump support adjacent to the spin-die manifold is not limited to a certain position of the pump support relative to the spin-die manifold. The pump support could also be arranged both horizontally and vertically adjacent to the spin-die manifold. The positioning of the pump support between a horizontal and vertical plane transversely adjacent to the spin-die manifold is also possible. Very short melt lines within the spin-die manifold may be realized with all possible arrangements such that both heating the melt predetermined in the pump support remains intact, and short dwell times of the melt can be obtained until extrusion.

In order to realize a plurality of spinning points in a compact construction in larger spinning systems, in one embodiment the pump support is arranged parallel to a longitudinal axis of the spin-die manifold such that the spinning pump and the bank of spinnerets are held in a mutual spinning plane lateral to the spin-die manifold. In this manner short melt lines may also be realized, which connect the spinning pump in the pump support to a bank of spinnerets in the spin-die manifold. For this purpose the pump support may generally be arranged above or transversely adjacent of the spin-die manifold. Heat carrier media are preferably utilized as heating devices, which flow around the melt-carrying components and assemblies to be temperature controlled in a heating chamber. For this purpose separate heating chambers are embodied in the spin-die manifold and the pump support.

The heating of the melt line arranged between the spinning pump and the bank of spinnerets may be achieved in one embodiment by a pipe connection, which is arranged between the heating chambers of the spin-die manifold and the pump support, and which surrounds the melt line at a distance in the manner of a jacket.

Separating the heating chamber may be achieved in one embodiment by a locking device that is embodied in the pipe connection, which seals the annular chamber in the pipe connection concentric to the melt line. In this manner an interaction between the heat carrier media in the heating chamber of the pump support with the heat carrier medium in the heating chamber of the spin-die manifold is excluded. Jacket seals or connecting pieces integrated in the pipe connection may be utilized as the locking device.

Providing a temperature-controlled heat carrier medium can be carried out depending on the requirement of the desired temperature control of the bank of spinnerets and the spinning pump by a mutual heat carrier source, or by multiple separate heat carrier sources.

In one embodiment, the heat carrier source is an evaporator that is connected to at least one of the heating chambers by a vapor connection and a condenser connection.

For the production of synthetic threads where the threads are produced from multiple polymer components, the polymer components may be combined within a bank of spinnerets that is adjusted the same in order to extrude the individual filament strands from multiple components. In order to feed the polymer melts, two or more spinning pumps are associated with the bank of spinnerets. In such units, one embodiment provides for multiple pump supports associated with the spin-die manifold, which hold one of multiple spinning pumps each, where the spinning pumps are connected to a bank of spinnerets by means of multiple melt lines. In this manner the single melt components may be temperature-controlled individually in the feed. The melt components are mutually temperature-controlled in the spin-die manifold shortly before extrusion.

In order to realize multiple spinning points, the plurality of banks of spinnerets are preferably held in the spin-die manifold in a row-shaped arrangement, where the spinning pump associated with the banks of spinnerets are also arranged in the pump support in a row-shaped arrangement. In this embodiment, all spinning pumps can be mutually temperature-controlled in that the pump support has multiple pump connection blocks within the heating chamber for connecting the spinning pumps and the melt line, where a cylindrical plug-in housing is associated with each pump connection block for accommodating one of the spinning pumps. In this manner, the heating chamber is utilized in order to mutually control the temperature of a plurality of spinning pumps and the connections and melt lines.

In order to prevent an over-heating of the spinning pumps, particularly at the drive end, the plug-in housing is preferably integrated on the pump support such that an open end of the plug-in housing protrudes from the heating chamber. Such an embodiment of the pump support is particularly advantageous also for the installation and disassembly of the spinning pumps. In this manner, the spinning pumps can be advantageously installed on the pump support from the exterior.

With the use of vaporous heat carrier media pressures usually occur within the heating chamber, which require minimum stabilities due to existing container regulations. In order to meet such requirements a pump support is provided, in which the pump support is embodied by a pipe, on which the plug-in housing and multiple pipe connections are attached. For this purpose the attachment can be realized by welded connections.

In another embodiment of the invention, in which the spin-die manifold has a nozzle accommodation opening on the top, and a spinning opening on the bottom, into which the bank of spinnerets can be inserted, is particularly advantageous in order to install the bank of spinnerets from the top of the spin-die manifold. Bank of spinnerets replacements can be carried out in a user-friendly manner. Installation and disassembly of the banks of spinnerets is carried out from the top of the spin-die manifold such that the cooling unit usually arranged on the bottom of the bank of spinnerets can be directly connected on the spin-die manifold in a compact construction for cooling the extruded filaments.

The device according to the invention is therefore suitable for all known types of banks of spinnerets that are utilized for the production of synthetic filaments. The banks of spinnerets may also be embodied with round nozzles or rectangular nozzle, or annular nozzles.

### BRIEF DESCRIPTION OF THE DRAWINGS

Some example embodiments of the device according to the invention are described in further detail below for the further explanation of the invention with reference to the attached drawings. They show:

FIG. 1 schematically a cross-sectional view of a first example embodiment of the device according to the invention;

FIG. 2 schematically a top view of the example embodiment of FIG. 1;

FIG. 3 schematically a cross-sectional view of a further example embodiment of the device according to the invention; and

FIG. 4 schematically a cross-sectional view of a further example embodiment of the device according to the invention.

### DETAILED DESCRIPTION

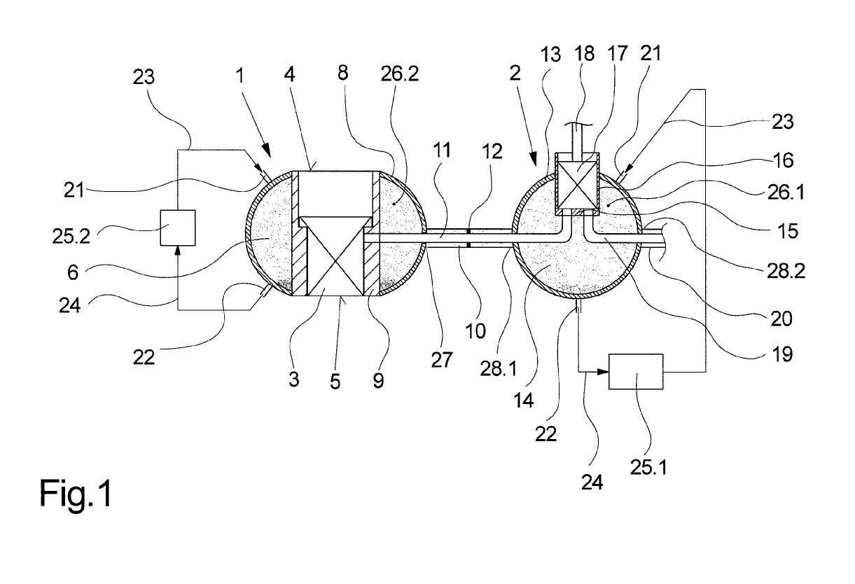

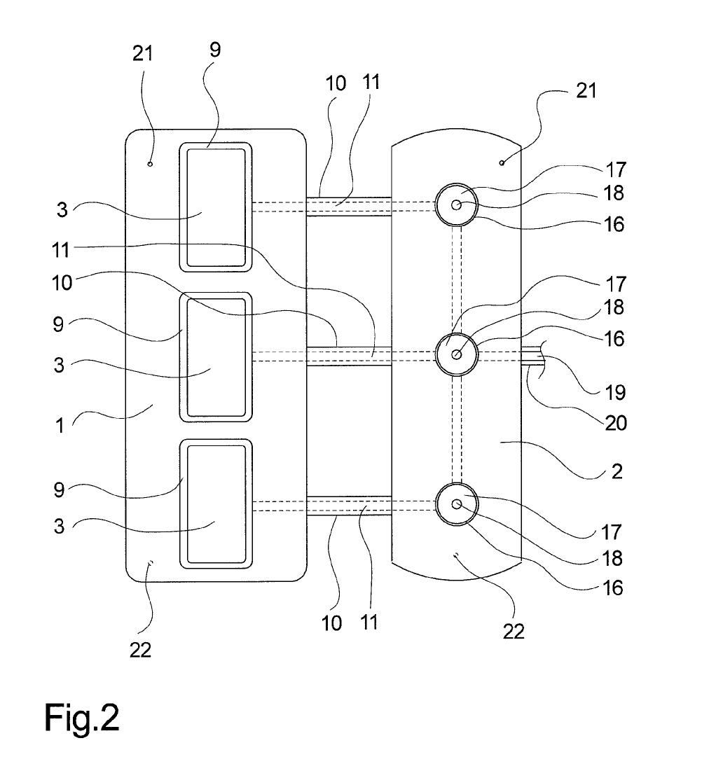

FIGS. 1 and 2 show a first example embodiment of the device according to the invention in multiple views. FIG. 1 shows the example embodiment schematically in a cross-sectional view, and in FIG. 2 the example embodiment is shown in a top view. The following description applies to both figures, unless express reference is made to one of the figures.

The example embodiment of the device according to the invention has a spin-die manifold 1 and a pump support 2, which are arranged parallel adjacent to each other.

As shown in FIG. 2, the pump support 2 substantially extends parallel to a longitudinal side of the spin-die manifold 1. Multiple banks of spinnerets 3 are held at the spin-die manifold 1 in a row-shaped arrangement. In this example embodiment, the banks of spinnerets 3 are each embodied by rectangular nozzles.

Multiple spinning pumps 17 are also held in a row-shaped arrangement on the pump support 2 extending adjacent to the spin-die manifold 1. For this purpose one of the spinning pumps 17 is associated with the bank of spinnerets such that the spinning pump 17 and the bank of spinnerets 3 are positioned in a mutual spinning plane transverse to the spin-die manifold 1. Each of the spinning pumps 17 is connected to the associated bank of spinnerets 3 via a melt line 11. The connection between the pump support 2 and the spin-die manifold 1 is formed by multiple pipe connections 10, in which the melt lines 11 are guided.

For the purpose of further explanation, reference is now also made to FIG. 1 in addition to FIG. 2. The schematic cross-sectional view shown in FIG. 1 shows the center arrangement of the bank of spinnerets 3 and the spinning pump 17 compared to FIG. 2. A spin-die manifold housing 8 that includes a heating chamber in the interior embodies the spin-die manifold 1. The spin-die manifold housing 8 is oval shaped in this example embodiment, and extends across the entire length of the spin-die manifold 1. The spin-die manifold housing 8 is sealed on all sides, thus forming the sealing chamber 6 that is hermetically sealed from the environment. The insulating materials on the spin-die manifold 1 usually additionally attached on the spin-die manifold housing 8 are not illustrated in this example embodiment.

A nozzle carrier 9 is inserted in the spin-die manifold housing 8 for accommodating the bank of spinnerets 3. The nozzle carrier 9 penetrates the spin-die manifold housing 8 from a top side to a bottom side in this example embodiment. Therefore, a nozzle accommodating opening 4 is formed on the top of the spin-die manifold 1, which corresponds to a spinning opening 5 positioned opposite of the bottom of the spin-die manifold 1. Therefore, the bank of spinnerets 3 can be installed in the nozzle carrier 3 from the top of the spin-die manifold 1 into the nozzle carrier 9. The bank of spinnerets 3 substantially protrudes up to the spinning opening 5.

The construction of the bank of spinnerets 3 is not explained in further detail at this point, as it is a generally known construction of spinnerets as is known in the art. Generally, the banks of spinnerets 3 have a nozzle plate including a plurality of nozzles bores on the bottom thereof, through which the filament strands are extruded.

The nozzle carrier 9 penetrates the spin-die manifold housing 8 such that free heating surfaces are created within the heating chamber 6 at each side of the nozzle carrier 9.

The melt line 11 is connected to the nozzle carrier 9 within the heating chamber 6, which is guided from a lateral feed opening 27 of the spin-die manifold housing 8 out from the spin-die manifold 1.

The pipe connection 10 is attached concentric to the feed opening 27 on the spin-die manifold housing 8. For this purpose, the pipe connection surrounds the melt line 11 such that a free area is formed between the pipe connection 10 and the melt line 11.

In the further course the melt line 11 is guided through a connection opening 28.1 of a pump support housing 13 to the pump support 2. The pump support housing 13 of the pump support 2 in the present embodiment is in the shape of a pipe, and has a pump connection block 15 for the connection of each of the spinning pumps 17. The pump connection block 15 is located within a heating chamber 14 formed by the pump support housing 13. The melt line 11 is connected at a bottom of the pump connection block 15 at the other end thereof such that a connection is created to the bank of spinnerets 3. A feed line 19 is connected to the pump connection block 15 parallel adjacent to the melt line 11. The feed line 19 is guided out of the heating chamber 14 via a second connection opening 28.2 in the pump support housing 13. An adapter 20 is connected to the pump connection block 15 concentric to the connection opening 28.2. For this purpose, the adapter 20 surrounds the feed line 19 in a jacket-like manner. The feed line 19 is connected to a distribution system (not illustrated) in the interior of the heating chamber 14 in order to supply the remaining spinning pumps 17 in the pump support 2 with melt.

In order to accommodate the spinning pump 17 a plug-in housing 16 is attached to the pump connection block 15, which protrudes from the pump support housing 13 at an open end thereof. The spinning pump 17 is held in the plug-in housing 16. For this purpose, the drive end of the spinning pump 17 with the drive shaft 18 is located outside of the pump support housing 13.

In order to temperature-control the melt-guiding parts within the pump support housing 13 a heat carrier medium 26.1 is fed in the heating chamber 14 as the heating device. The heat carrier medium 26.1 is fed via a heat source 25.1, preferably in the form of vapor. For this purpose, the heat source 25.1 is connected to the heating chamber 14 via a vapor line 23 having a vapor connection 21. The melt line 11, the feed line 19, the pump connection block 15, and the part of the plug-in housing 16 positioned in the interior are flowed through and temperature-controlled by the heat carrier medium 26.1 within the heating chamber 14.

So that the heat carrier medium 26.1 does not reach the heating chamber 6 of the spin-die manifold housing 8 via the connection opening 28.1 and the pipe connection 10, a locking device in the form of a jacket seal 12 is provided within the pipe connection 10, which seals the free space between the melt line 11 and the pipe connection 10. In this manner, the mutual exchange of the heat carrier media 26.1 and 26.2 guided in the heat chambers 6 and 14 is therefore prevented. Optionally, the jacket seal 12 could also be embodied by a connection piece, for example a flange connector between the pipe connection pieces, wherein one part of the pipe connection could be welded to the spin-die manifold housing 8 and the other part of the pipe connection could be welded to the pump support housing 13.

A condenser connection 22 is provided in the lower region of the pump support housing 13 by which the heating chamber 14 is connected to the heat source 25 via a condenser line 24. In this manner the condensate collected within the heating chamber 14 can be returned to the heat source 25.1. For this purpose, the heat source 25.1 is embodied preferably as an evaporator, by which a heat carrier cycle is realized. In this manner a continuous renewal of the heat carrier medium 26.1, and thus a uniform temperature control of the melt-carrying part held on the pump support 2 is ensured.

The heating chamber 14 extends within the pump support housing 13 across the entire length of the pump support 2 such that all spinning pumps 17 and melt lines 11 held on the pump support 2 are temperature-controlled. An insulating jacket may also be associated with the pump support housing 13 for the purpose of heat insulation.

The heating chamber 6 formed by the spin-die manifold housing 8 is also connected to a second heat source 25.2 via a vapor connection 21 and a condenser connection 22. For this purpose the heat source 25.2 creates a heat carrier medium 26.2 that is guided into the heating chamber 6 via the vapor line 23 in a vaporous state. A condensate present within the heating chamber 6 is returned to the heat source 25.2 via the condenser connection 22 and the condenser line 24. In this case, the heat source 25.2 also as an evaporator, by which a heat carrier cycle is formed.

In the example embodiment illustrated in FIGS. 1 and 2 the melt-carrying components held in the pump support 2 are mutually temperature-controlled by the heat carrier medium 26.1. The melt-carrying components held in the spin-die manifold 1 are separately heated by a second heat carrier medium 26.2 such that an individual temperature control that is adjusted to the assemblies is possible. In this manner the heat carrier medium 26.1 can be provided, for example, at a lower heating temperature, than the heat carrier medium 26.2. Energy is supplied to the polymer melt by means of the shear energy of the spinning pumps 17 such that the temperature control is possible using a heat carrier medium 26.1 that is less hot. In contrast any heat loss possibly occurring in the polymer melt during the extrusion in the polymer melt would have to be compensated such that the heat carrier medium 26.2 is adjusted to a higher heating temperature.

Advantageously the spinnerets 3 and the spinning pumps 17 are installed or disassembled in the spin-die manifold 1 and the pump support 2 from the top such that short service interruptions can be realized during maintenance work.

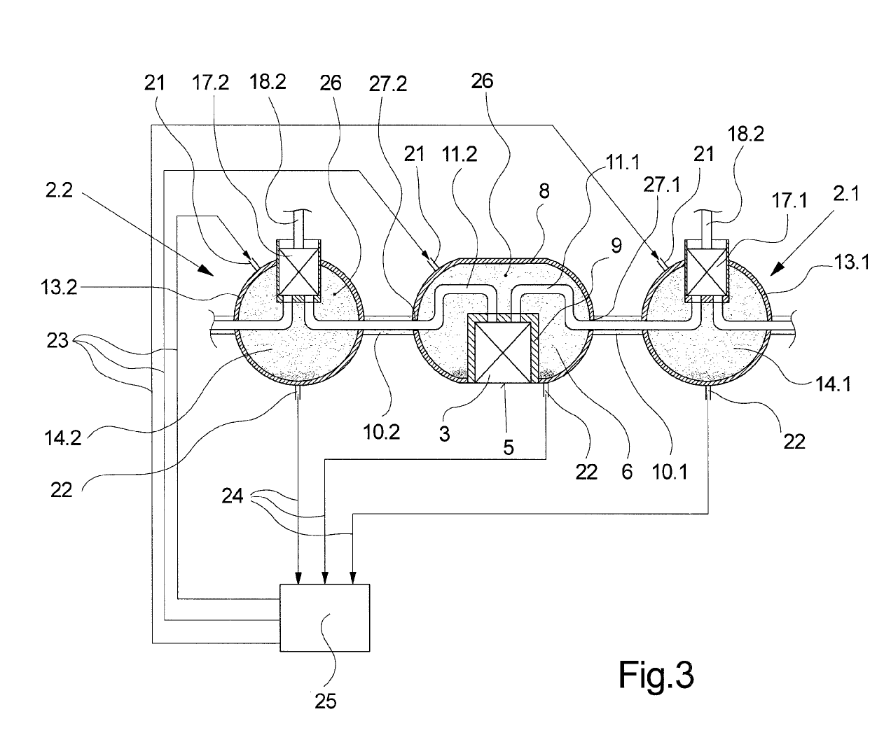

FIG. 3 shows a further example embodiment of the device according to the invention, which is illustrated in a schematic cross-sectional view.

In the example embodiment according to FIG. 3 a bank of spinnerets 3 is held within the spin-die manifold 1, which is suitable for melt spinning of a multi-component fiber. For this purpose multiple polymer melts having different compositions are supplied to the bank of spinnerets 3. In the example embodiment according to FIG. 3 the bank of spinnerets 3 is coupled to two melt lines 11.1 and 11.2 within the spin-die manifold housing 8. The bank of spinnerets could therefore be embodied, for example, as a so-called Biko bank of spinnerets.

To accommodate the bank of spinnerets 3 a cup-shaped nozzle carrier 9 is integrated in the spin-die manifold housing 8 from the bottom of the spin-die manifold 1. The cup-shaped nozzle carrier 9 comprises the connections to the melt lines 11.1 and 11.2 at a closed end protruding within the spin-die manifold housing 8. The nozzle carrier 9 is open toward the bottom and forms the spinning opening 5. In this manner the bank of spinnerets 3 can be installed in the nozzle carrier 3 via the spinning opening 5.

The melt lines 11.1 and 11.2 are guided out from the spin-die manifold housing 8 on both sides of the spin-die manifold 1. For this purpose the spin-die manifold housing 8 has two feed openings 27.1 and 27.2 that are positioned opposite of each other. The pipe connections 10.1 and 10.2 are attached concentric to the feed openings 27.1 and 27.2, which are each connected to a pump support 2.1 and 2.2 at the free ends thereof. The pump supports 2.1 and 2.2 extend along both longitudinal sides of the spin-die manifold 1 and hold one of the spinning pumps 17.1 and 17.2.

The pump supports 2.1 and 2.1 are embodied identical to the pump support 2 of the previously mentioned example embodiment according to FIGS. 1 and 2. Reference is made to the previously mentioned description in order to avoid any repetition.

The heating chamber 6 formed in the spin-die manifold housing 8, and the heating chambers 14.1 and 14.2 formed in the pump support housing 13.1 and 13.2 are coupled to a heat source 25. A heat carrier medium 26 is fed to each of the heating chambers 14.1 and 14.2 via the heat source 25. The feeding is carried out via separate vapor lines 23 and separate vapor connections 21. Separate condenser connections 22 are associated with each of the heating chambers 6, 14.1, and 14.2, by which separate condenser lines 24 are connected to a heat source 25.

In the example embodiment illustrated in FIG. 3 all melt-carrying components in the spin-die manifold 1 and in the pump supports 2.1 and 2.2 can therefore be uniformly temperature-controlled.

However, it is generally also possible to embody the heating device of the spin-die manifold 1 and the pump support 2.1 and 2.2 differently. In this manner each of the heating chambers 6, 14.1 and 14.2 can be coupled to separate heat sources 25 such that different heat carrier media are utilized within each heating chamber 6, 14.1 and 14.2 for heating the melt-carrying components. In these cases the pipe connections 10.1 and 10.2 each have a locking device, preferably jacket seals or flange connections. Therefore the heating chambers 6, 14.1 and 14.2 are separated from each other and can be heated separately.

A further alternative embodiment using locking devices in the pipe connections 10.1 and 10.2 is possible in that the heating chambers 14.1 and 14.2 are heated by a mutual heat source.

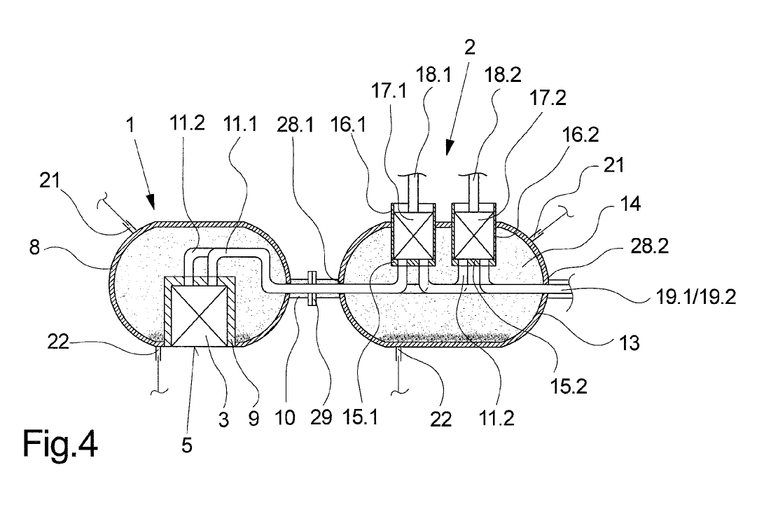

FIG. 4 shows a further example embodiment of the device according to the invention, wherein multiple spinning pumps 17.1 and 17.2 are also associated with a bank of spinnerets 3.

The example embodiment according to FIG. 4 is illustrated schematically in a cross-sectional view. Contrary to the example embodiments according to FIG. 3 mentioned above, the spinning pumps 17.1 and 17.2 are mutually held in a pump support 2 in this case. For this purpose two pump connection blocks 15.1 and 15.2 arranged parallel next to each other are provided in the pump support housing 13. Plug-in housings 16.1 and 16.2 are associated with the pump connection blocks 15.1 and 15.2, which protrude from the pump support housing 13 at the open ends thereof. For this purpose the drive shafts 18.1 and 18.2 of the spinning pumps 17.1 and 17.2 are positioned parallel adjacent to each other such that they may, for example, be advantageously driven by a mutual drive.

Two feed lines 19.1 and 18.2 are guided into the interior of the pump support housing 13 via a connection opening 28.2, and connected to one of the pump connection blocks 15.1 and 15.2. One of the melt lines 11.1 and 11.2 is coupled to each of the pump connection blocks 15.1 and 15.2, which represent the connection to the bank of spinnerets 3. The melt lines 11.1 and 11.2 are guided out from the pump support housing 13 through the connection opening 28.1. A pipe connection 10 is provided in the transitional area between the pump support housing 13 and the spin-die manifold housing 8, which surrounds the melt lines 11.1 and 11.2. A connecting piece 29 is provided as the locking device within the pipe connection 10, by which a separation between the pump support 2 and the spin-die manifold 1 is formed in order to prevent a mixing of heat carrier media that is guided in the interior of the housings 8 and 13.

The melt lines 11.1 and 11.2 are connected to the bank of spinnerets 3 via a nozzle carrier 9 in the interior of the spin-die manifold housing 8. In this case the bank of spinnerets 3 is also embodied for extruding multiple component filaments.

The function of the variation of the device according to the invention illustrated in FIG. 4 is identical to the example embodiments mentioned above such that no further explanations are provided at this point. However, for this purpose both fed melt components are equally heated within the pump support 2 utilizing an identical heat carrier medium.

The example embodiments of the device according to the invention shown in FIGS. 1 to 4 are provided as an example with regard to the construction and arrangement of the individual assemblies. For example, one or multiple spinning pumps could be arranged in the pump support such that the drive shaft of the spinning pump extends horizontally, or is directed vertically toward the bottom. The separation between the spin-die manifold and the separate pump support according to the invention provides high flexibility in the arrangement and embodiment of the driven spinning pumps. Furthermore, banks of spinnerets and spinning pumps that are easy to operate, particularly with regard to installation and disassembly, can be realized in this manner.

The spinning pumps in the pump support may also be embodied as multiple pumps, which are connected via multiple melt lines to multiple spinnerets.

One spinneret could also be connected to more than two spinning pumps in order to spin a multiple-component thread.

While various embodiments of the invention have been particularly shown and described, it will be understood by those skilled in the art that various changes in form and details may be made therein without departing from the spirit and scope of the invention as defined by the appended claims. For example, the spin-die manifold and the pump support of the example embodiments have heating chambers having a heat carrier medium as the heating device. However, the invention is not limited to such heating device. It is also possible to embody the heating device of the spin-die manifold, or the heating device of the pump support, or both heating device as electric heating units.

### LIST OF REFERENCE SYMBOLS

1 spin-die manifold
2, 2.1, 2.2 pump support
3 bank of spinnerets
4 nozzle accommodation opening
5 spinning opening
6 heating chamber
8 spin-die manifold housing
9 nozzle carrier
10, 10.1, 10.2 pipe connection
11, 11.1, 11.2 melt line
12 jacket seal
13, 13.1, 13.2 pump support housing
14, 14.1, 14.2 heating chamber
15, 15.1, 15.2 pump connection block
16, 16.1, 16.2 plug-in housing
17, 17.1, 17.2 spinning pump
18, 18.1, 18.2 drive shaft
19, 19.1, 19.2 feed line
20 pipe connection
21 vapor connection
22 condenser connection
23 vapor line
24 condenser line
25 heat source
26.1, 26.2 heat carrier medium
27 feed opening
28.1, 28.2 connection opening
29 connection piece

1. A device for melt spinning of synthetic filaments having at least one bank of spinnerets, the device comprising:
a spin-die manifold constructed and arranged to accommodate the at least one bank of spinnerets;
a heating device constructed and arranged to heat the at least one bank of spinnerets, the heating device having at least one spinning pump;
a second heating device constructed and arranged to heat the at least one spinning pump, the at least one spinning pump and the at least one bank of spinnerets being operatively connected by a melt line; and
wherein the at least one spinning pump and the second heating device are held in a separate pump support, which is arranged at a distance adjacent to the spin-die manifold.

2. The device according to claim 1, wherein the pump support is arranged parallel to a longitudinal side of the spin-die manifold such that the at least one spinning pump and the at least one bank of spinnerets are held at a mutual spinning plane, transverse to the spin-die manifold.

3. The device according to claim 2, wherein the pump support and the spin-die manifold are positioned adjacent to each other.

4. The device according to claim 1, wherein the heating device includes a heat carrier medium guided in a heating chamber in the spin-die manifold, and wherein the heating device further includes a second heat carrier medium guided in a heating chamber in the pump support.

5. The device according to claim 4, wherein the heating chamber in the spin-die manifold and the heating chamber in the pump support are interconnected by a pipe connection, and wherein the melt line is guided in the pipe connection.

6. The device according to claim 5, further comprising a locking device disposed in the pipe connection concentric to the melt line, and which separates the heating chamber in the spin-die manifold from the heating chamber in the pump support.

7. The device according to claim 6, wherein the heat carrier media is fed to the heating chamber in the spin-die manifold and the heating chamber in the pump support by a mutual heat carrier source.

8. The device according to claim 6, wherein the heat carrier media is fed to the heating chamber in the spin-die manifold and the heating chamber in the pump support by multiple, separate heat carrier sources.

9. The device according to claim 1, wherein the spin-die manifold further includes a nozzle accommodation opening at a top, and a spinning opening at a bottom, sized to receive the at least one bank of spinnerets inserted therein.

10. The device according to claim 1, wherein the at least one spinning pump comprises multiple spinning pumps connected to the at least one bank of spinnerets by multiple melt lines.

11. The device according to claim 10, further comprising multiple pump supports operatively associated with the spin-die manifold, each pump support constructed and arranged to support one of a multiple of spinning pumps.

12. The device according to claim 11, wherein the at least one bank of spinnerets comprises multiple banks of spinnerets that are arranged in a row, and wherein the multiple pump supports are arranged in a row, which interact with the banks of spinnerets.

13. The device according to claim 10, wherein the pump support within the heating chamber includes multiple pump connection blocks constructed and arranged to connect the spinning pumps with the corresponding melt lines, wherein a cylindrical plug-in housing is associated with each pump connection block for accommodating one of the spinning pumps.

14. The device according to claim 13, wherein the plug-in housings protrude from the heating chamber at an open end thereof.

15. The device according to claim 13, wherein the pump support includes a pipe, on which the plug-in housings and multiple pipe connections are secured.

16. The device according to claim 1, further comprising a heat carrier source including an evaporator connected to the heating device via a vapor connection and a condenser connection.
